(19) United States
(12) Patent Application Publication
(10) Pub. No.: US 2023/0111164 A1
(43) Pub. Date: Apr. 13, 2023

(54) LOW-COST, HIGH-VOLUME PRODUCTION METHOD FOR AEROGEL MONOLITH PRODUCTION IN AUTOMOTIVE APPLICATIONS

(71) Applicant: Ford Global Technologies, LLC, Dearborn, MI (US)

(72) Inventor: Haibo Zhao, Northville, MI (US)

(73) Assignee: Ford Global Technologies, LLC, Dearborn, MI (US)

(21) Appl. No.: 17/499,821

(22) Filed: Oct. 12, 2021

(51) Int. Cl. B28B 5/02; B29C 39/02; B29C 39/38; B29C 39/44; B29C 39/22; B28B 11/24

(52) U.S. Cl. CPC B28B 5/021; B29C 39/02; B29C 39/38; B29C 39/44; B29C 39/22; B28B 11/24; B29K 2105/0061

(57) ABSTRACT

A method of producing a plurality of parts includes placing a sol mixture into a cavity of a tool, optionally placing a metal foil over a top of the cavity and placing a graphite gasket over the metal foil, and securing the tool with the sol mixture to form a tooling capsule. Tooling capsules are placed within a conveyor system and are heated until the solvent of the sol mixture reaches at least supercritical conditions of the solvent. Pressure is released within each of the tooling capsules after the supercritical conditions are reached, and then the tooling capsules are cooled to approximately room temperature. The parts are removed from the tooling capsules, and the method is continuous.

### FIELD

The present disclosure relates to a method of manufacturing parts using aerogel or a sol material, and more specifically to manufacturing parts using such materials for applications in motor vehicles.

### BACKGROUND

The statements in this section merely provide background information related to the present disclosure and may not constitute prior art.

Nanoporous materials exhibit a wide array of unique material properties. The use of nanoporous materials for thermal insulation provides light-weight and lower volume parts which can also prevent thermal runaway propagation. This is particularly desirable as thermal barriers in battery arrays for electric vehicles and as thermal management for various electronic components in vehicles. In vehicle design, lower volume parts are desired as vehicle bodies are already crowded and space is limited.

Conventional manufacturing methods, such as those using super critical drying methods, are time-consuming and require relatively expensive high-temperature and high-pressure equipment. Furthermore, these methods provide for production on a comparatively smaller scale (i.e., parts in hundreds). This makes the conventional methods undesirable for automotive applications. In the automotive industry, large scale production (i.e., parts in millions) is generally employed to fulfill demands.

The present disclosure addresses high volume production challenges related to advanced, light-weight materials.

### SUMMARY

This section provides a general summary of the disclosure and is not a comprehensive disclosure of its full scope or all of its features.

A method of producing a plurality of parts is provided that includes placing a sol mixture into a cavity of a tool, the sol mixture comprising a solvent. Next, a metal foil is place over a top of the cavity and a graphite gasket is placed over the metal foil. The tool with the sol mixture, the metal foil, and the graphite gasket are secured together to form a tooling capsule. A plurality of tooling capsules are placed within a conveyor system, and the plurality of tooling capsules are heated until the solvent of the sol mixture reaches at least supercritical conditions of the solvent. Pressure is released from each of the plurality of tooling capsules after the supercritical conditions are reached, the plurality of tooling capsules are cooled to approximately room temperature, and the parts are removed from the plurality of tooling capsules, wherein the method is continuous.

In variations of this method, which may be employed individually or in any combination: the solvent comprises at least one of ethanol and methanol; the heating is carried out by at least one of resistance heaters and induction heating; the cooling is carried out by at least one of a blower and a chiller; a speed of the conveyer system is variable based on the solvent of the sol mixture; a heating profile of the heating step is variable based on the solvent of the sol mixture; a spacing between tooling capsules is variable based on the solvent of the sol mixture; at least one of a temperature and the pressure within each of the plurality of tooling capsules is monitored; the pressure within each of the plurality of tooling capsules is released at a predetermined value using a pressure release valve; the pressure release valve is a needle valve; the plurality of tooling capsules comprise a variety of different sol mixture compositions; the tooling capsules are heated without an external restraining force; applying a mold release agent to the cavity before placing the sol mixture into the cavity; the sol mixture comprises an aerogel material; the aerogel material comprises a precursor selected from the group consisting of silica, alumina, titania, hafnium carbide, polymers, and chalcogenide semiconductors; and after the parts are removed from the tooling capsules, the tooling capsules are automatically transported to a filling station where a sol mixture is placed into the cavity of each tooling capsule, followed by reforming the tooling capsule and automatically transporting the plurality of reformed tooling capsules to the conveyor system, thereby forming a closed-loop continuous method.

In another form, a method of producing a plurality of parts includes placing a sol mixture into a cavity of a tooling capsule, the sol mixture comprising a solvent, placing a plurality of tooling capsules with the sol mixture within a conveyor system, heating the plurality of tooling capsules until the solvent of the sol mixture reaches at least supercritical conditions of the solvent, releasing a pressure within each of the plurality of tooling capsules after the supercritical conditions are reached, cooling the plurality of tooling capsules to approximately room temperature, and removing the parts from the plurality of tooling capsules, wherein the method is continuous.

In a variation of this method, the tooling capsules are heated without an external restraining force.

In yet another form, a method of producing a plurality of parts includes placing a sol mixture into a cavity of a tooling capsule, the sol mixture comprising a solvent, placing a plurality of tooling capsules with the sol mixture within a conveyor system, heating the plurality of tooling capsules until the solvent of the sol mixture reaches at least supercritical conditions of the solvent, releasing a pressure within each of the plurality of tooling capsules after the supercritical conditions are reached, cooling the plurality of tooling capsules to approximately room temperature, removing the parts from the plurality of tooling capsules, automatically transporting the plurality of tooling capsules to a filling station where a sol mixture is placed into the cavity of each tooling capsule, and automatically transporting the plurality of tooling capsules back to the conveyor system, thereby forming a closed-loop continuous method.

In a variation of this method the tooling capsules are heated without an external restraining force.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side cross-sectional view of a tooling capsule used in a method according to the present disclosure;

FIG. 2A is a schematic view of a system for producing a plurality of parts according to one form of the present disclosure;

FIG. 2B is a schematic view of a variation of the system of producing a plurality of parts illustrated in FIG. 2A;

FIG. 3 is a schematic view of a system of producing a plurality of parts according to another form of the present disclosure;

FIG. 4 is a flowchart outlining a method of producing a plurality of parts according to the present disclosure;

FIG. 5 is a scanning electron microscopy (SEM) image of a surface morphology of a graphene aerogel monolith constructed according to the teachings of the present disclosure; and

FIG. 6 is a graph of pressure over time measured for a sample part manufactured according to the methods of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

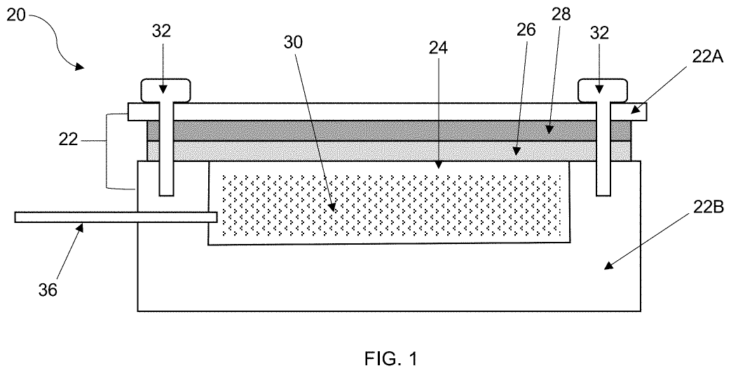

Referring to FIG. 1, a tooling capsule for producing parts using a sol mixture is illustrated and generally indicated by reference numeral 20. The tooling capsule 20 generally includes a tool 22 comprising an upper tool portion 22A and a lower tool portion 22B, and a cavity 24 formed in the lower tool portion 22B. The cavity 24 may be formed in one or both of the upper and lower tool portions 22A/22B and is generally in the shape of the part to be formed. Therefore, the configuration of the cavity 24 in the lower tool portion 22B is merely exemplary and should not be construed as limiting the scope of the present disclosure.

The cavity 24 is configured to be filled with a sol mixture 30. The sol mixture 30 includes a solvent, which may be methanol or ethanol according to different forms of the present disclosure. In one form, the sol mixture 30 is an aerogel material. The aerogel material comprises a precursor selected from the group consisting of silica, alumina, titania, hafnium carbide, polymers, and chalcogenide semiconductors, among others. By way of nonlimiting example, the sol mixture may comprise about 15.5 mL of tetraethylorthosilicate (TEOS), about 20 mL of absolute ethanol (Abs. EtOH), about 0.5 mL of water, and about 6 mL of 0.01 M oxalic acid. These components are combined to form a mixture and the mixture is stirred for about 15 minutes. The mixture is then allowed to rest for about 45 minutes. About 0.5. mL of 0.325 M ammonium hydroxide is then added to the mixture and the resultant mixture is then mixed for about 1-2 minutes. Further, a mold release agent may be applied to the interior surfaces of the cavity 24 before placing the sol mixture 30 into the cavity 24.

The tooling capsule 20 further comprises an optional metal foil 26 placed over the top of the cavity 24 and an optional graphite gasket 28 placed over the metal foil 26 as shown. The metal foil 26 and graphite gasket 28 provide a high temperature seal during the high temperature forming process, as described in greater detail below. Further details of the gaskets and other components of a similar tool is illustrated and described in U.S. Pat. No. 7,384,988, which is incorporated herein by reference in its entirety. (For clarity and ease of viewing, the metal foil 26 and the graphite gasket shown in FIG. 1 are not drawn to scale).

The upper and lower tool portions 22A/22B, the metal foil 26, and the graphite gasket 28 are secured together using, by way of example, mechanical fasteners such as bolts 32 as shown. Importantly, the tool 22 is held together statically and is not subjected to an external restraining force during heating, such as by way of example a hot press. As a result, the tooling capsule 20 is easily and rapidly transported through a variety of processing stations as set forth in greater detail below.

As further shown, the tooling capsule 20 further comprises a pressure release valve 36, which in one form is a needle valve. The pressure release valve 36 is in fluid communication with the cavity 24 and the outside environment as shown, and when the pressure during elevated temperature processing (described in greater detail below) reaches a predetermined level, pressure is released from the cavity 24. Generally, this method is referred to as the Rapid Supercritical Extraction (RSCE) process.

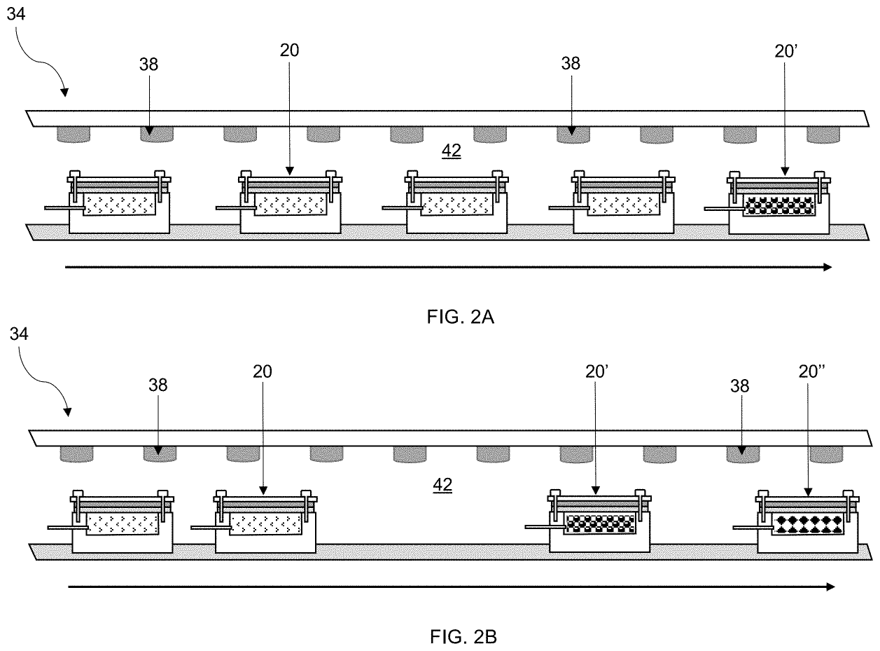

Referring now to FIG. 2A, in order to facilitate a relatively high production rate, a plurality of tooling capsules 20 are placed within a conveyor system 34 and are heated until the solvent of the sol mixture 30 reaches at least supercritical conditions. By way of nonlimiting example, for ethanol, the supercritical conditions comprise a pressure greater than or equal to about 800 pounds per square inch (psi) and a temperature greater than or equal to about 290° C. Each of the plurality of tooling capsules 20 may comprise a variety of different sol mixture compositions. For example, one tooling capsule 20 may include silica as a precursor in the sol mixture 30, while another tooling capsule 20′ may include alumina as a precursor. Alternately, each of the tooling capsules 20 may comprise the same sol mixture composition.

In one aspect of the present disclosure, a speed of the conveyor system 34 is variable based on the solvent of the sol mixture 30. Some sol compositions may require longer processing times than others, for example, and thus the speed of the conveyor system 34 can be varied if both sol materials are in queue along the conveyor system 34. As shown in FIG. 2B, a spacing between the capsules 20, 20′, 20″ is variable based on the solvent or other compositional elements of the sol mixture 30.

In order to provide the requisite heat to activate the sol composition, heating in one form is provided by resistance heaters 38. However, heating may be carried out by a variety of means including, by way of example, induction heating or forced heated air, among others.

As set forth above, the plurality of tooling capsules 20 are heated without an external restraining force. In other words, the plurality of tooling capsules 20 have no external pressure/force applied by another device (e.g., hot press) throughout the conveyor system 34 and are instead moving as independent units through a heated environment 42 as the temperature and pressure of the sol composition within the cavity 24 steadily increases to the supercritical conditions as set forth herein.

In a further aspect of the present disclosure, a heating profile throughout the conveyor system 34 is variable based on the solvent or other compositional elements of the sol mixture 30. The heating profile is generally the change in temperature over a given time period, and thus the ramp up rate, ramp down rate, and any hold times can be set as a function of the tooling capsule 20 configuration and the specific sol composition(s).

During heating, the sol mixture 30 undergoes gelation. The pressure within each of the plurality of tooling capsules 20 is released after the supercritical conditions of the solvent are reached. In one aspect of the present disclosure, the pressure within each of the plurality of tooling capsules 20 is released at a predetermined value using the pressure release valve 36. The pressure release valve 36 may be a needle valve; however, the present disclosure is not limited thereto. In another aspect of the present disclosure, at least one of a temperature and the pressure within each of the plurality of tooling capsules 20 is monitored using, for example, a thermocouple (not shown) attached to the tooling capsule and a pressure sensor (not shown) disposed within the cavity. Other manners of monitoring at least one of the temperature and the pressure within each of the plurality of tooling capsules may be used without deviating from the scope of the present disclosure. Monitoring of the temperature and the pressure within the tooling capsules tracks the heating profile of the sol mixture and the expected release of pressure after the supercritical conditions of the solvent are reached.

After heating, the plurality of tooling capsules 20 are cooled to approximately room temperature and the parts are removed from the plurality of tooling capsules 20. As used herein, the term “room temperature” should be construed to mean about 77° F. (about 25° C.). In one aspect of the present disclosure, the cooling is carried out by at least one of a blower and a chiller. However, the present disclosure is not limited thereto. Further details of a drying process are set forth in greater detail below in the “Testing” section.

As used herein, the term “continuous” should be construed to mean that the plurality of tooling capsules 20 are continually and progressively moving and being processed through the conveyor system 34 such that a high production volume of parts is generated. In one form, the “high production” is about 60-240 parts per hour.

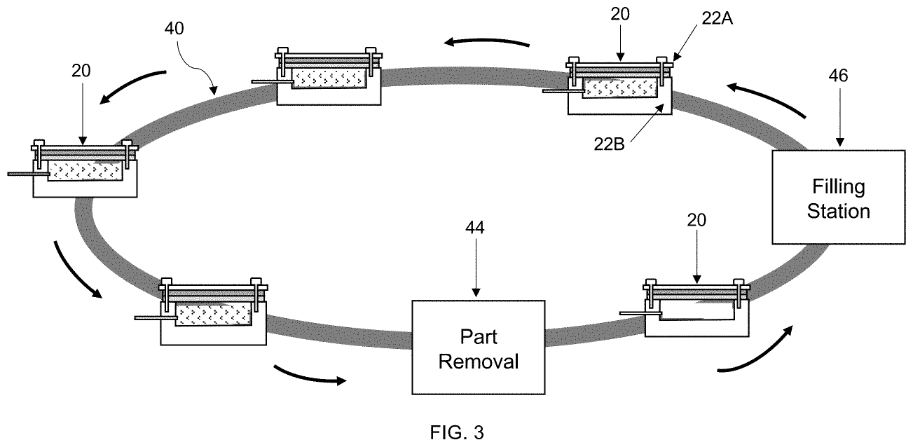

Referring now to FIG. 3, in another form of the present disclosure, a plurality of tooling capsules 20 with the sol mixture 30 are placed within a closed-loop conveyor system 40. The tooling capsules 20 are heated until the solvent of the sol mixture 30 reaches at least supercritical conditions of the solvent and a pressure within each of the tooling capsules 20 is released after the supercritical conditions of the solvent are reached as described above. In this form, the parts are removed at a removal station 44 from the tooling capsule 20, and then the tooling capsule 20 is automatically transported to a filling station 46 where a sol mixture 30 is placed into the cavity 24 of each tooling capsule 20, followed by reforming (securing the upper tool portion 22A to the lower tool portion 22B) the tooling capsule 20 and automatically transporting the tooling capsule 20 through the closed-loop conveyor system 40, thereby forming a closed-loop continuous method. Optionally, the tooling capsules 20 are cleaned and a mold release agent is applied to the interior of the cavity 24 after the parts are removed and before the tooling capsules are transported to the filling station 46.

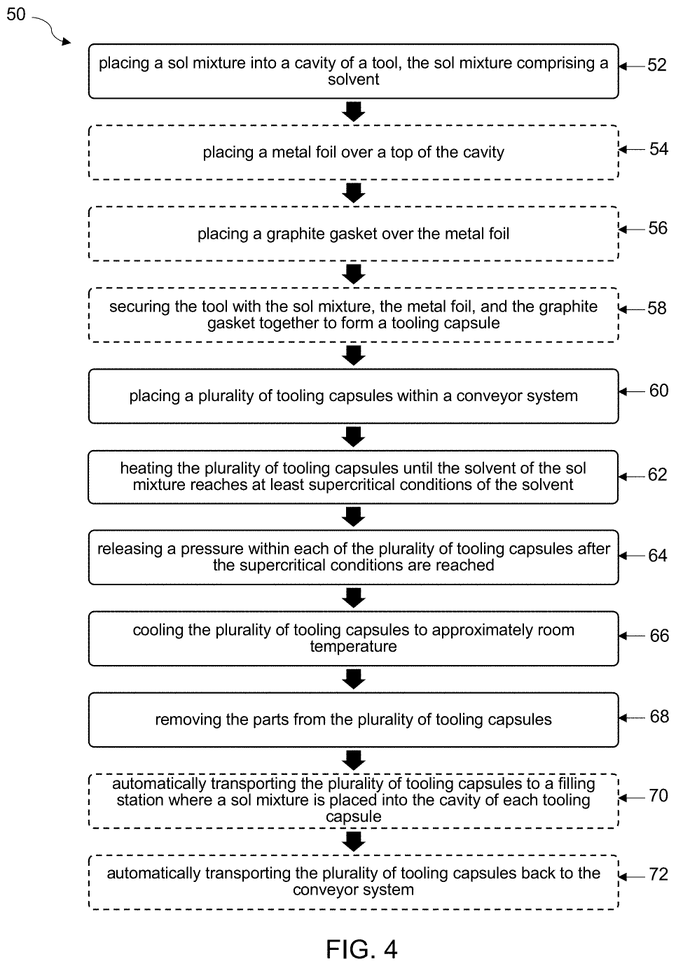

Referring now to FIG. 4, a method of producing a plurality of parts 50 comprises placing a sol mixture into a cavity of a tool, the sol mixture comprising a solvent, at 52. Optionally, the method 50 may further comprise placing a metal foil over a top of the cavity, at 54, and placing a graphite gasket over the metal foil, at 56. The method 50 then comprises securing the tool with the sol mixture, and optionally the metal foil and the graphite gasket, together to form a tooling capsule, at 58.

At 60, a plurality of tooling capsules are placed within a conveyor system. The method 50 further comprises heating the plurality of tooling capsules until the solvent of the sol mixture reaches at least supercritical conditions, at 62, and releasing a pressure within each of the plurality of tooling capsules after the supercritical conditions of the solvent are reached, at 64.

The plurality of tooling capsules are cooled to approximately room temperature, at 66, and the parts are removed from the plurality of tooling capsules, at 68. Optionally, the method 50 further comprises automatically transporting the plurality of tooling capsules to a filling station where a sol mixture is placed into the cavity of each tooling capsule, at 70, and automatically transporting the plurality of tooling capsules back to the conveyor system, at 72.

Testing

The material properties, in particular the density, the thermal conductivity, and the burn characteristics, of parts produced by the methods according to the present disclosure were studied. The densities of sample parts measuring about 25 mm in height and 50 mm in diameter were tested. The bulk density measured as low as 0.0531 g/cm³.

The thermal conductivity of sample parts produced by the methods according to the present disclosure was measured to be 0.020 W/(m·K). This value was lower and on par with parts produced by RSCE methods in the past, which were 0.030-0.040 W/(m·K).

Burn tests were conducted on sample parts produced by the methods according to the present disclosure using a torch and a thermal camera. In particular, the ignitability, flame spread, and heat release were studied. During the burn test, the torch burned at about 1000° C. After about 10 seconds, the parts produced by the methods according to the present disclosure remained at ambient temperature (i.e., no temperature change due to the torching). In addition, the part did not ignite and had low to no heat release and heat spread.

Surface area measurements were also taken from the test samples, which were outgassed for about 5 hours at about 200° C. A 5-point Brunauer-Emmett-Teller (BET) analysis was used to determine the surface area, and the results are shown below in Table 1:

TABLE 1
Surface Area Test Results

| Aging (h) | Surface Area (m²/g) |
|---|---|
| 0 | 526.4295 |
| 12 | 233.4783 |
| 36 | 690.4756 |
| 60 | 577.4830 |

As shown, the surface area increases over the time period from 12 to 36 hours and decreases slightly at 60 hours. It has been shown that longer aging of silica wet gels results in stronger and stiffer aerogels post fabrication, which is likely due to the gel being able to create a more complete network of pores. These surface areas are generally low for silica aerogels but are consistent with aerogels fabricated with the RSCE process.

Samples with graphene were also fabricated with the modified RSCE process according to the present disclosure. Graphene powder was added to the solution and mixed before gelation. A 2.0 wt. % loading of graphene in a silica aerogel monolith demonstrated no cracking after fabrication. However, a 7.0 wt. % loading of graphene showed significant cracking.

A facile two probe method using a multimeter showed that through the addition of graphene, the aerogel became conductive. Accordingly, the use of graphene with aerogel can be implemented in a variety of applications with this property, such as by way of example, solid state battery anode applications.

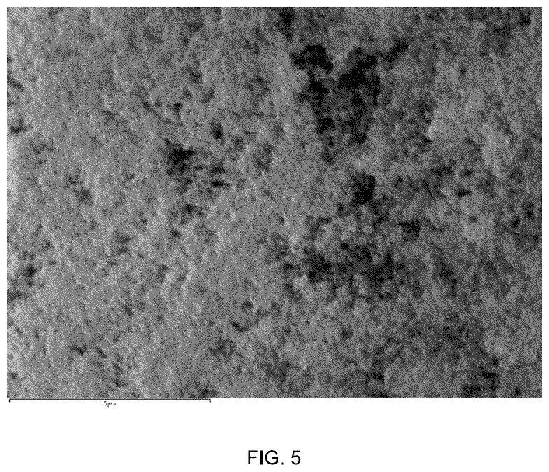

Referring to FIG. 5, the surface morphology of the graphene reinforced aerogels fabricated according to the present disclosure has a porous structure.

A variety of other materials for the aerogel/sol material and their thermal conductivities are shown below in Table 2:

TABLE 2
Thermal Conductivity of Aerogel Materials

| | Thermal Conductivity |
|---|---|
| Aerogel Materials | (W/m · K) |
| Silica aerogel monolith | 0.030 |
| Silica aerogel monolith infused glass mat | 0.028 |
| 2% Graphene/Silica aerogel | 0.034 |
| 7% Graphene/Silica aerogel | 0.040 |
| Infused aerogel blanket with acrylic spray coating | 0.041 |
| Infused aerogel blanket | 0.040 |

As shown, the materials that were tested exhibited excellent low thermal conductivity. Silica aerogel infused glass mat monolith had slightly lower thermal conductivity than samples without the glass mat. Graphene is thermally conductive and therefore the addition of graphene in silica aerogel increased the thermal conductivity. The higher the loading of graphene is in aerogel, the higher the thermal conductivity will be. However, the propensity for cracking increases with a higher loading of graphene without a controlled drying/cooling process. An acrylic clear coating was used to seal the surface of the aerogel blanket so that loose silica aerogel powder would not fall off the blanket during handling. The data shows that relatively thin (about 1-10 μm) clear coating does not cause much change to the thermal insulating property of the aerogel blanket.

The drying process for the samples was carefully controlled to avoid cracking. As set forth above, both temperature and pressure of the tooling capsule are monitored and, in one form, pressure and temperature changes are recorded every 15 minutes. Such monitoring allows for control of the conditions of the solvent in the superfluid phase during the drying process.

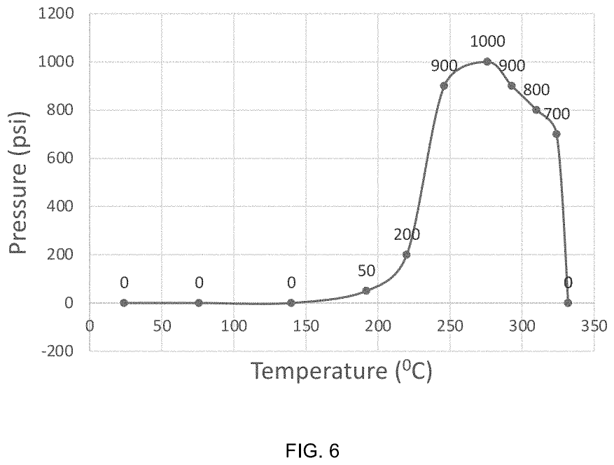

Referring to FIG. 6, the pressure vs temperature for one example control run is shown. There was no discernable pressure change observed over the first 30 minutes of the temperature ramp-up. The pressure started increasing around 150° C. and increased very rapidly after around 230° C. The pressure peaked at 1,000 psi in 1.5 hours then started slowly dropping down as gas seeped out. The needle valve was opened (one turn) at 320° C. and held for 30 minutes before being fully opened. The pressure quickly dropped once the needle valve was opened completely. The heat was then turned off and the tooling capsule was allowed to naturally cool to room temperature.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of producing a plurality of parts, the method comprising:
placing a sol mixture into a cavity of a tool, the sol mixture comprising a solvent;
placing a metal foil over a top of the cavity;
placing a graphite gasket over the metal foil;
securing the tool with the sol mixture, the metal foil, and the graphite gasket together to form a tooling capsule;
placing a plurality of tooling capsules within a conveyor system;
heating the plurality of tooling capsules until the solvent of the sol mixture reaches at least supercritical conditions of the solvent;
releasing a pressure within each of the plurality of tooling capsules after the supercritical conditions are reached;
cooling the plurality of tooling capsules to approximately room temperature; and
removing the parts from the plurality of tooling capsules,
wherein the method is continuous.

2. The method according to claim 1, wherein the solvent comprises at least one of ethanol and methanol.

3. The method according to claim 1, wherein the heating is carried out by at least one of resistance heaters and induction heating.

4. The method according to claim 1, wherein the cooling is carried out by at least one of a blower and a chiller.

5. The method according to claim 1, wherein a speed of the conveyer system is variable based on the solvent of the sol mixture.

6. The method according to claim 1, wherein a heating profile of the heating step is variable based on the solvent of the sol mixture.

7. The method according to claim 1, wherein a spacing between tooling capsules is variable based on the solvent of the sol mixture.

8. The method according to claim 1, wherein at least one of a temperature and the pressure within each of the plurality of tooling capsules is monitored.

9. The method according to claim 1, wherein the pressure within each of the plurality of tooling capsules is released at a predetermined value using a pressure release valve.

10. The method according to claim 9, wherein the pressure release valve is a needle valve.

11. The method according to claim 1, wherein the plurality of tooling capsules comprise a variety of different sol mixture compositions.

12. The method according to claim 1, wherein the tooling capsules are heated without an external restraining force.

13. The method according to claim 1, further comprising applying a mold release agent to the cavity before placing the sol mixture into the cavity.

14. The method according to claim 1, wherein the sol mixture comprises an aerogel material.

15. The method according to claim 14, wherein the aerogel material comprises a precursor selected from the group consisting of silica, alumina, titania, hafnium carbide, polymers, and chalcogenide semiconductors.

16. The method according to claim 1, wherein after the parts are removed from the tooling capsules, the tooling capsules are automatically transported to a filling station where a sol mixture is placed into the cavity of each tooling capsule, followed by reforming the tooling capsule and automatically transporting the plurality of reformed tooling capsules to the conveyor system, thereby forming a closed-loop continuous method.

17. A method of producing a plurality of parts, the method comprising:
placing a sol mixture into a cavity of a tooling capsule, the sol mixture comprising a solvent;
placing a plurality of tooling capsules with the sol mixture within a conveyor system;
heating the plurality of tooling capsules until the solvent of the sol mixture reaches at least supercritical conditions of the solvent;
releasing a pressure within each of the plurality of tooling capsules after the supercritical conditions are reached;
cooling the plurality of tooling capsules to approximately room temperature; and
removing the parts from the plurality of tooling capsules,
wherein the method is continuous.

18. The method according to claim 17, wherein the tooling capsules are heated without an external restraining force.

19. A method of producing a plurality of parts, the method comprising:
placing a sol mixture into a cavity of a tooling capsule, the sol mixture comprising a solvent;
placing a plurality of tooling capsules with the sol mixture within a conveyor system;
heating the plurality of tooling capsules until the solvent of the sol mixture reaches at least supercritical conditions of the solvent;
releasing a pressure within each of the plurality of tooling capsules after the supercritical conditions are reached;
cooling the plurality of tooling capsules to approximately room temperature;
removing the parts from the plurality of tooling capsules;
automatically transporting the plurality of tooling capsules to a filling station where a sol mixture is placed into the cavity of each tooling capsule; and
automatically transporting the plurality of tooling capsules back to the conveyor system, thereby forming a closed-loop continuous method.

20. The method according to claim 19, wherein the tooling capsules are heated without an external restraining force.
